(19) United States
(12) Patent Application Publication
(10) Pub. No.: US 2023/0320422 A1
(43) Pub. Date: Oct. 12, 2023

(54) Heating Apparatus for an Aerosol Generating Device

(71) Applicant: JT International SA, Geneva (CH)

(72) Inventors: Andrew Robert John Rogan, Forres (GB); Alec Wright, Guildford (GB)

(73) Assignee: JT International SA, Geneva (CH)

(21) Appl. No.: 18/005,482

(22) PCT Filed: Jul. 6, 2021
(86) PCT No.: PCT/EP2021/068722

§ 371 Date: Jan. 13, 2023

(30) Foreign Application Priority Data
Jul. 17, 2020 (EP) 20186579.7

(51) Int. Cl. A24F 40/46; A24F 40/20; A24F 40/57; A24F 40/60; H05B 1/02

(52) U.S. Cl. CPC A24F 40/46; A24F 40/20; A24F 40/57; A24F 40/60; H05B 1/0244; H05B 2203/016

(57) ABSTRACT

An aerosol generating device includes a heating chamber having a cavity for receiving an aerosol generating medium; a heating element extending along a length of the cavity and configured to heat the aerosol generating medium; a base plate that is moveable along the length of the cavity and is in contact with the heating element to provide an electrical contact, where movement of the base plate changes the position of the electrical contact; and one or more electrical connections configured to deliver electrical energy to the heating element so as to heat a portion of the heating element according to the position of the electrical contact.

### BACKGROUND

Known aerosol generating devices, such as e-cigarettes and tobacco vapour products, often use a heating apparatus to heat an aerosol generating medium in order to generate an aerosol or vapour, for inhalation by a user. The aerosol generating medium is commonly inserted into a heating chamber of the device in the form of a consumable plug or cartridge. Different types of consumables are available and the sizes of these consumables may vary; however, many existing aerosol generating devices are restricted to receiving specific consumables due to differences in the dimensions of the consumables, the heating chamber, and the heating apparatus.

Generally, aerosol generating devices are configured to accept a single type of consumable of a single size. In some known devices spring or elastic mechanisms are used as a supporting member in assembly a device. Such mechanisms typically have a spring or coil which is compressed to a single fixed, locked position for operation, and then further acts as a release or ejection mechanism for the device.

In other known devices a heating element may include a pairs of heating tracks for electrical energy to run up and down the heating element. The pairs of heating tracks are arranged at different lengths along the heating element to provide different active heating lengths for the device.

Due to these specific configurations, there is a problem that these devices cannot accept different types of consumables and effectively heat them. It is therefore an aim of the present invention to provide a heating apparatus for an aerosol generating device that can efficiently heat consumables of different shapes and sizes.

### SUMMARY

According to an aspect of the invention, there is provided an aerosol generating device comprising: a heating chamber comprising a cavity for receiving an aerosol generating medium; a heating element extending along a length of the cavity and configured to heat the aerosol generating medium; a base plate that is moveable along the length of the cavity and is in contact with the heating element to provide an electrical contact, where movement of the base plate along the cavity changes the position of the electrical contact along a length of the heating element; one or more electrical connections configured to deliver electrical energy to the heating element so as to heat a portion of the heating element according to the position of the electrical contact, and wherein the heating element comprises a single variable heater length for heating a received aerosol generating medium.

In this way the heating element may be automatically adjusted to only be heated along a portion of the heating element that is within the cavity. The movement of the base plate, or cavity bottom, defines the size of the cavity and the length of the heating element within cavity is the only portion required to provide heat to a received aerosol generating medium. By providing an electrical contact between the base plate and the heating element, the position of the base plate along the length of the heating chamber can be determined, and the portion of the heating element required to provide heat can be controlled accordingly. This advantageously provides an efficient way to control the heating element portion for heating the received aerosol generating medium.

It should be understood that the base plate and the heating element are configured such that the electrical contact is a single point of electrical contact along the length of the heating element. This means that the heating element is a single continuous element (or comprises a single variable heater length) such that the portion of the heating element that heats a received aerosol generating medium is determined by the length between the single electrical contact position and an end of the heating element. Preferably movement of the electrical contact along the single variable heater length directly varies an amount of electrical energy delivered to the heating element.

The aerosol generating device could equally be referred to as a “heated tobacco device”, a “heat-not-burn tobacco device”, a “device for vaporising tobacco products”, and the like, with this being interpreted as a device suitable for achieving these effects. The features disclosed herein are equally applicable to devices which are designed to vaporise any aerosol generating medium.

The term “consumable” refers to an aerosol generating medium, a cartridge or other container comprising an aerosol generating medium, or any other component suitable for delivering an aerosol generating medium into the device such that an aerosol may be generated. In some preferable examples of the invention, the consumable comprises a rod shaped aerosol generating medium such as a tobacco stick which is configured to be heated to release a vapour without burning the aerosol generating medium. By providing a heating chamber with an adjustable cavity length determined by the position of the base plate, the length of the cavity can automatically adjust to the length of the rod shaped consumable upon insertion in to the chamber.

Preferably the electrical connections are arranged to heat a portion of the heating element corresponding to a portion between the electrical contact and an end of the heating element. In this way, the aerosol generating device may be configured to heat a portion of the heating element between the base plate and an end of the heating element. Preferably the heating chamber comprises an opening at one end and the electrical connections are arranged to heat a portion of the heating element between the electrical connect of the base plate and an end of the heating element nearest the opening. In this way, as an aerosol generating medium is inserted into the cavity through the opening, the base plate and contact are moved so as to heat a portion of the heating element corresponding to a length of the aerosol generating medium received within the cavity.

Preferably the base plate comprises a ground connection. In this way the ground connection in the base plate effectively controls the electrical energy provided to the heating element, i.e. the heating element portion, in the heating chamber. It should be understood that the moveable base plate thereby acts as the ground connection for the heating element. Advantageously this means that any length of consumable and any length of portion of heating element to heat an aerosol generating medium can be provided along the length of the heating element.

Preferably the ground connection is in contact with a wall of the heating chamber. In this way the heating chamber may be used to further direct delivered electrical energy from the heating element. The wall of the heating chamber may be configured to provide a return path for the electrical energy.

Preferably the wall of the heating chamber comprises a guide configured to engage with the ground connection. In this way a more secure connection may be provided between the base plate and the heating chamber. For example the ground connection may be configured to engage with the guide, thereby providing continuous electrical contact between the heating element and the heater chamber. The ground connection may be configured to slide along the guide.

Preferably the base plate is configured to move under contact with the aerosol generating medium as it is received in the heating chamber. In this way differently sized consumables may be received into the chamber, or cavity of the chamber, as the base plate is moved by the contact of the aerosol generating medium to a position such that the length of the aerosol generating medium may be accommodated in the chamber. By allowing the base plate to move under contact, a suitably sized cavity for heating can be provided for the aerosol generating medium as it is received.

Preferably the base plate is movable to an extraction position for removing a used aerosol generating medium from the heating chamber. In this way after a cartridge or aerosol generating medium has been spent can be more easily removed. For example the base plate may be moved to or proximate to the opening of the cavity of the heating chamber such that a user can more easily grip the aerosol generating medium for removal.

Preferably the aerosol generating device further comprises a power control configured to adjust the electrical energy provided to the heating element depending on the position of the electrical contact. Preferably the power control is configured to deliver current to a portion of the heating element between the electrical contact and an end of the heating element. In this way a more efficient system is provided as only the required amount of electrical energy is delivered to the heating element. The power control may be adjusted automatically or manually in relation to the electrical contact position.

Preferably the aerosol generating device further comprises a position control arranged to control the position of the base plate. The position control may be a manual control or an electronically controlled drive. In this way the movement of the base plate can be effectively controlled. It should be understood that a user may wish to adjust the position of the base plate before inserting an aerosol generating medium, or after partially or fully inserting the aerosol generating medium to provide an optimally sized cavity for heating and aerosol generation.

Preferably the position control comprises a biasing member arranged to provide a restoring force to the base plate toward an opening in the heating chamber through which the aerosol generating medium is received. In this way the base plate can be biased to move to a neutral position in the chamber. The neutral position may be the extraction position for an aerosol generating medium, or alternatively the neutral position may be for a typically-sized, or smallest commercially available, consumable where the base plate may be moved further toward the opening of the cavity for extraction or away from the opening (toward the base of the cavity) to accommodate longer consumables.

The heating element may also be configured such that the length of the heating zone, or the active heating portion/segment, is determined by the position of the base plate (or cavity bottom). For instance a portion of the heating element to generate heat may be determined by the distance between the base plate and an end of the heating element toward the opening of the heating chamber. In this way the heating element does not have discrete heating zones, rather a continuous length of the heating element being sectioned by the base plate. For example the control circuitry may determine the required length of the heating element for receiving electrical energy by an electrical contact provided between the base plate and the heating element along the length of the heating element. In this way the heating portion (i.e. active heating length) could be any specific length of the heating element rather than requiring specific discrete zones. It should be understood that aspects in this disclosure relating the described individual heating zones are equally applicable to a continuously variable length heating zone.

It is possible that the heating element may comprise a plurality of individual heating zones for heating a received aerosol generating medium. In this way an appropriate length of the heating element (which may be defined as a heating zone) may be determined to heat the aerosol generating medium. For example the position control may be in communication with further control circuitry to control an amount of electrical energy delivered to the heating element in discrete levels depending on the position of the electrical contact. In other words the single variable heater length may be used in a way to provide discrete heating zones.

Providing a heating element with multiple heating zones, or segments, that can be independently heated allows the apparatus to only heat those segments which are arranged or configured to efficiently heat the consumable. Heating zones that are not selected to be directly heated, i.e. activated, in order to heat a consumable received in the heating chamber, are herein referred to as unused heating zones (or unused zones/segments). Typically, this is because the unused zone is not able to heat the consumable efficiently. For example, an unused heating segment may not be in contact with the consumable, or only a small portion of the consumable is in contact with the unused heating segment. A required heating segment (or required segment) refers to a heating segment that has been selected to be directly heated in order to heat a consumable held in the heating chamber and is any heating segment that is not an unused segment.

To put it in another way, if a shorter plug is received in the heating chamber, a single or smaller number of heating zones/segments of the heating element can be used to provide heat to the plug. Similarly if a longer plug is inserted into the heating chamber, a greater number of heating zones of the heating element are used to heat the plug.

The continuously variable active heater length or the multiple discrete heating zones that are individually activated advantageously ensures heat generated by a heating element is delivered effectively to a consumable for aerosol generation, thereby improving efficiency of the device. It should be understood that the variable length or the one or more heating zones used to heat the received aerosol generating medium should substantially correspond with the length of the aerosol generating medium in the cavity.

Dividing the heating element into a continuously variable length, or a larger number of heating zones/segments, which can be independently heated, allows for an improved level of control over the heating of a consumable. Furthermore, when the heating element is divided into a larger number of heating zones, the length of a given consumable will more precisely match the area occupied by an integral number heating zones.

Preferably the heating element extends through a plate opening in the base plate. The plate opening may be a slit or other shaped narrow opening in the base plate in order for the heating element to pass through the body or central portion of the base plate. Preferably the heating blade extends through an opening in the base plate, wherein the base plate is moveable along the length of the heating blade. The size of the opening may provide a close fit around the outer perimeter of the heating element, when viewed in the direction along the length of heating element (i.e. the direction in which the heating element may penetrate an inserted consumable). In this way the heating element can act as a guide for the base plate as it moves along the heating chamber and heating element, thereby providing further support to the base plate. A close fit between the heating element and the base plate can ensure that a secure electrical contact is provided between the heating element and the base plate.

Preferably the heating element comprises a heating blade, the heating blade configured to pierce the aerosol generating medium when received in the heating chamber. In this way when a consumable is in the heating chamber, the heating blade may heat the consumable from the interior. Furthermore, the heating blade may secure or assist securing the consumable within the heating chamber. It should therefore be understood that after the heating blade has pierced an inserted consumable, the portion of the heating blade between the base plate and an end of the heating blade that pierced the consumable can receive electrical energy from the battery to generate heat. This active heating blade portion may comprise one or more of the individual heating zones in the heating element/blade, which can therefore be determined by the point of contact between the base plate and the heating blade end. Preferably the heating blade comprises a plurality of heating zones arranged along the length of the heating blade.

Preferably the heating blade comprises a piercing end directed towards the opening of the heating chamber. The piercing end of the heating blade is directed towards the opening of the heating chamber and narrows towards the opening. The piercing end facilitates the insertion of the consumable into the heating chamber. This may be through piercing a hole in the consumable for (at least a portion of) the heating blade to pass into or to ease inserting the heating blade into a slot already present in the consumable.

### BRIEF DESCRIPTION OF THE DRAWINGS

Examples of the present invention will now be described in detail with reference to the accompanying drawings, in which:

FIG. 1 is a schematic view of an aerosol generating device according to an example of the present invention;

FIG. 2 is a schematic view of a heating apparatus for an aerosol generating device according to an example of the present invention;

FIG. 3 is a schematic view of a heating apparatus for an aerosol generating device according to an example of the present invention;

FIG. 4 is a schematic view of a heating apparatus for an aerosol generating device according to an example of the present invention; and

FIG. 5 is a schematic view of a heating apparatus for an aerosol generating device according to an example of the present invention.

### DETAILED DESCRIPTION

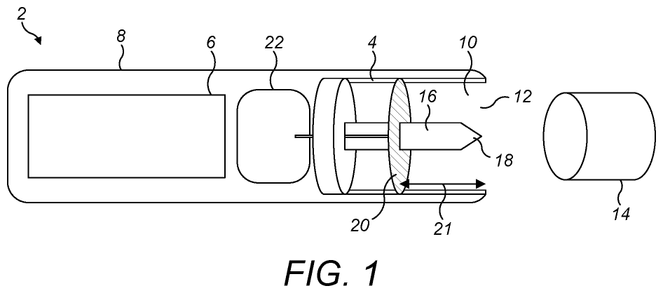

FIG. 1 shows an aerosol generating device 2 comprising a heating system 4 and a battery 6 provided within a housing 8 of the aerosol generating device 2. The heating system 4 comprises a heating chamber 10 having an opening 12 for receiving an aerosol generating consumable 14, such as a plug, and a heating element 16, such as a heating blade, where the heating element 16 receives electrical energy from the battery 6 to generate heat. It should be understood that an inserted consumable 14 forms an aerosol for inhalation as it is heated by the heating element 16. A mouthpiece and/or other aerosol guiding means (not shown) may be connected to the aerosol generating device 2 as will be apparent to the person skilled in the art. In other examples, the consumable may comprise a mouthpiece and the consumable and chamber are arranged such that the mouthpiece of the consumable extends from the opening of the chamber to allow inhalation during use. The consumable may comprise a tobacco rod with a filter element providing the mouthpiece.

The heating element 16 comprises a piercing end 18 configured to pierce into and/or pass through the consumable 14 as it is introduced to the heating chamber 10 such that, in use, the consumable 14 is heated from its interior. The piercing end 18 of the heating element 16 is directed towards the opening 12 of the heating chamber 10.

The heating chamber 10 further comprises a base plate 20, or cavity bottom, which is arranged to receive the consumable 14 such that a consumable 14 is in contact with the base plate 20 after insertion. The base plate 20 is configured to move along the length of the chamber 10 relative to the heating element 16 in order to define the length 21 of the heating chamber 10, or heating cavity for the aerosol generating consumable 14. In other words a user may push a consumable plug 14 into the chamber 10 such that it comes into contact with the base plate 20, and that the base plate 20 is configured to move further away from the opening 12 until the plug 14 is fully inserted into the chamber 10.

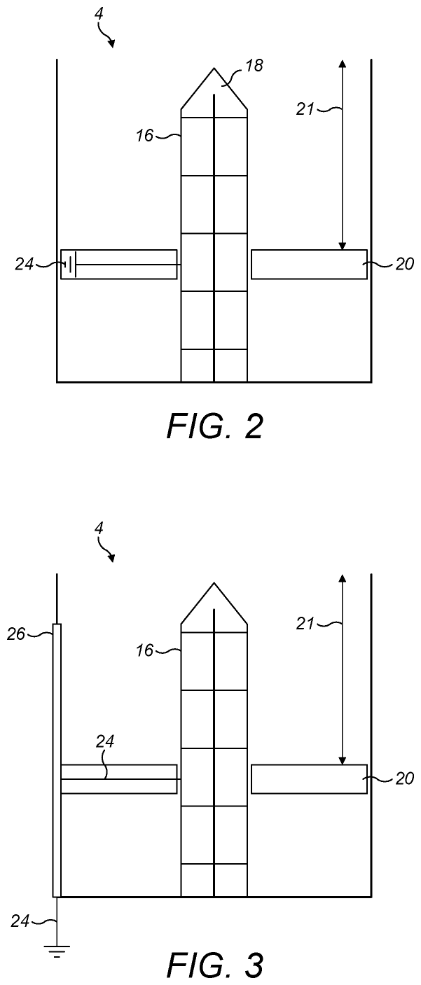

The heating element 16 is arranged such that it extends through a plate opening in the base plate 20 which allows the heating element to act as a guide for the base plate 20 as it moves relative to the heating element 16. The position or location of the base plate 20, relative to the heating element 16, is used to determine an active length of the heating element 16 required to heat an inserted consumable 14. The heating element 16 may be divided into segments or zones as seen more clearly in FIGS. 2 and 3, and the active length may be provided as a discrete number of active segments in the heating element 16.

The heating element 16 and the base plate 20 are electrically connected via one or more electrical connections (not shown). The aerosol generating device 2 further comprises control circuitry 22 which is configured to detect the position of the base plate 20 in the heating chamber 10 and/or the length of the heating chamber 10 between the opening 12 and the base plate 20 based on the position of the electrical contact between the heating element 16 and the base plate 20. Therefore it should be understood that as electrical energy is delivered from the battery 6 to the heating element 16, the electrical energy may be returned or otherwise channelled away from the heating element 16 via the electrical contact provided via the base plate 20. Alternative configurations of the electrical connections between the heating element 16 and the base plate 20 would be readily apparent to the person skilled in the art.

The aerosol generating device 2 further comprises control circuitry 22 which is configured to detect the length 21 of the heating chamber 10 between the opening 12 and the base plate 20, or indeed the piercing end 18 and the electrical contact between the base plate 20 and the heating element 16. In an example the control circuitry 22 can be automatically initiated to detect/determine an active heating element 16 length when the base plate 20 is displaced from a neutral position (i.e. when no plug 14 is in the chamber 10). The control circuitry 22 controls the active length of the heating element 16, which as described above may be the number of segments, or heating zones, to receive electrical energy. The control circuitry 22 can also control the amount of electrical energy that is delivered from the battery 6 to the heating element 16. Therefore it should be understood that a more efficient aerosol generating device is provided by individually controlling the heating zones and/or controlling the battery consumption by the control circuitry 22. The heating element 16 may have heating tracks passing into the heating zones which can be controlled by the control circuitry 22.

FIGS. 2 to 5 show the heating element 16 having the piercing end 18 and five additional segments or zones that can be individually controlled by the control circuitry 22 to generate heat when electrical energy from the battery 6 is delivered to one or more of the zones. However it should be understood that the heating element 16 may comprise of any number of individual heating segments.

FIG. 2 shows a schematic representation of the heating system 4 where the base plate 20 comprises a ground connection 24. As should be understood the ground connection 24 acts as a return or exit path for the electrical energy delivered to the heating element 16.

FIG. 3 shows another schematic arrangement of the ground connection 24 where the ground connection 24 is incorporated into the wall 26 of the heating chamber 10. It should therefore be understood that an electrical connection is also provided between the base plate 20 and the wall 26 such that a return path for electrical energy can be provided from the heating element 16 to the wall 26 via the base plate 20.

The base plate 20 engages with the wall 26 in a continuous way to maintain the ground connection 24. An example of providing continuous contact between the may be to provide the portion of the ground connection 24 in the wall 26 within a guide (not shown), and the base plate 20 includes portion, such as a projection, which is arranged to move in the guide as the base plate 20 moves along the wall 26. It should be understood that the guide and projection can advantageously provide structural support to the moving components in the heating system 4.

An aerosol generating medium is not shown in FIGS. 2 to 5, but it should be appreciated that the base plate 20 is configured to move along the length of the heating chamber 10.

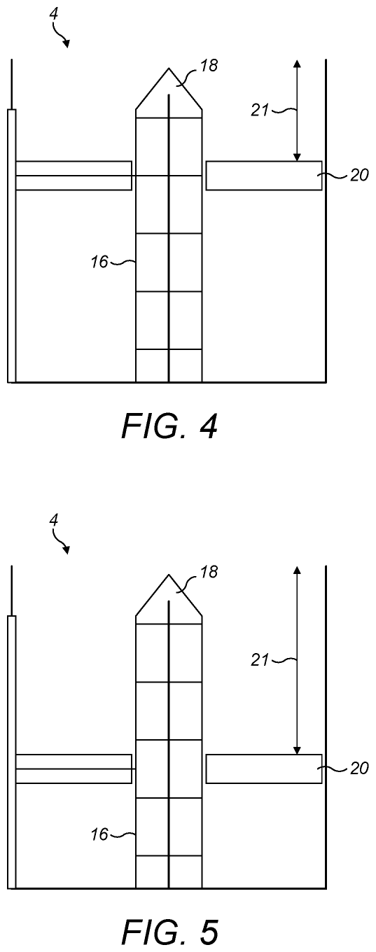

FIGS. 4 and 5 show the heating system 4 where the base plate 20 is arranged at different positions along the length of the heating element 16. FIG. 4 shows the heating system 4 where the base plate 20 exposes the piercing end 18 and one heating segment 26 of the heating element 16, and Figure the base plate 20 at a lower, or deeper, position in the heating chamber 10 such a further heating element segment is exposed to an inserted consumable.

The aerosol generating device 2 may include a position control mechanism for the base plate 20 which allows the base plate 20 to be moved to a suitable depth in the heating chamber 10 for receiving an aerosol generating consumable. Such a position control mechanism can be manual or electronically controlled system as will be apparent to the person skilled in the art. For example a manual push mechanism having a lever or sliding button on an outer surface of the aerosol generating device 2 may be provided for a user to extract a spent plug from the chamber 10. In another example the base plate position control may be an automatic system, such as a providing a biasing member on the underside of the base plate 20 such that the biasing member provides a restoring force to the base plate 20 to restore the base plate to a predetermined neutral position in the heating chamber.

The aerosol generating device 2 may also include an extraction or ejection mechanisms to remove a spent consumable plug. This extraction/ejection mechanism can be incorporated into the base plate position control system.

1. An aerosol generating device comprising:
a heating chamber comprising a cavity for receiving an aerosol generating medium;
a heating element extending along a length of the cavity and configured to heat the aerosol generating medium, wherein the heating element comprises a single variable heater length for heating the aerosol generating medium;
a base plate that is moveable along the length of the cavity and is in contact with the heating element to provide an electrical contact, where movement of the base plate along the cavity changes a position of the electrical contact along a length of the heating element; and
one or more electrical connections configured to deliver electrical energy to the heating element so as to heat a portion of the heating element according to the position of the electrical contact.

2. The aerosol generating device of claim 1, wherein movement of the electrical contact along the single variable heater length directly varies an amount of electrical energy delivered to the heating element.

3. The aerosol generating device of claims 1, wherein the base plate comprises a ground connection configured to act as a return path for the delivered electrical energy.

4. The aerosol generating device of claim 3, wherein the ground connection is in contact with a wall of the heating chamber.

5. The aerosol generating device of claim 4, wherein the wall of the heating chamber is configured to extend the return path for the electrical energy.

6. The aerosol generating device of claim 5, wherein the wall of the heating chamber comprises a guide configured to engage with the ground connection.

7. The aerosol generating device of claim 1, wherein the base plate is configured to move under contact with the aerosol generating medium as the aerosol generating medium is received in the heating chamber.

8. The aerosol generating device of claim 1, wherein the base plate is movable to an extraction position for removing a used aerosol generating medium from the heating chamber.

9. The aerosol generating device of claim 1, further comprising a power control configured to adjust the electrical energy provided to the heating element depending on the position of the electrical contact.

10. The aerosol generating device of claim 1, further comprising a position control arranged to control a position of the base plate.

11. The aerosol generating device of claim 10, wherein the position control is a manual control or an electronically controlled drive.

12. The aerosol generating device of claim 10, wherein the position control comprises a biasing member arranged to provide a restoring force to the base plate toward an opening in the heating chamber through which the aerosol generating medium is received.

13. The aerosol generating device of claim 1, wherein the heating element extends through a plate opening in the base plate.

14. The aerosol generating device of claim 1, wherein the heating element comprises a heating blade, the heating blade configured to pierce the aerosol generating medium when received in the heating chamber.

15. The aerosol generating device of claim 14, wherein the heating blade comprises a piercing end directed towards an opening of the heating chamber.
